(19) United States
(12) Patent Application Publication
(10) Pub. No.: US 2015/0306779 A1
(43) Pub. Date: Oct. 29, 2015

(54) COVERING OR LAYERED MATERIAL SLITTING DEVICE AND METHOD

(71) Applicant: Michael J. Napolitano, Coventry, CT (US)

(72) Inventor: Michael J. Napolitano, Coventry, CT (US)

(21) Appl. No.: 14/259,416

(22) Filed: Apr. 23, 2014

(51) Int. Cl. B26D 3/08

(52) U.S. Cl. CPC B26D 3/085

(57) ABSTRACT

Methods and apparatus are provided for the slitting of material using a wheeled slitting apparatus. One example includes a carriage body having wheels and a handle and a blade positioning device attached to the carriage. The blade positioning device has a body that includes a slot and a clamping bar positioned in the slot and further includes a cutting blade positioned within the slot between the body and the clamping bar and held in place by a handwheel assembly that clamps the cutting blade between the body and the clamping bar in a tightened position. Such an apparatus provides for a safe, fast and efficient technique for slitting materials such as roofing membranes, carpeting, vinyl flooring and the like.

### BACKGROUND OF THE INVENTION

1. Field of the Invention

Embodiments of the present invention generally relate to a tool for slitting sheets, membranes, coverings, coatings, layers and the like and, more particularly, to an improved blade positioning and change device.

2. Description of the Related Art

Utility knives are hand held devices that are commonly used to aid in the removal of covering materials such as roofing membranes, carpeting, vinyl flooring and the like. The user typically kneels or bends over, holds the housing, applies downward pressure while pulling the knife towards the user and uses the blade for cutting the covering materials. The use of the utility knife in such manner can be dangerous to the user and the depth of the cut may vary greatly. Some of the deficiencies of the prior art utility knives were solved by the wheeled slitting tool device disclosed in U.S. Pat. No. D415,174, entitled “roofing tool” wherein a common utility knife was adjustably attached to a wheeled carriage allowing for the fixed positioning of the utility knife with respect to the covering material to be cut. The wheeled slitting tool of the prior art was positioned with its wheels on top of the material to be cut allowing the user to stand away from the blade and push the wheeled slitting tool, and the cutting blade thereby, away from the user's body.

Utility knives typically comprise a knife housing that is provided with a slot that receives a blade such that the blade extends from the housing. The blade of the typical utility knife includes a plurality of slots opposite the cutting edge that cooperate with at least on locking tab in the knife housing to fix the position of the blade relative to the knife housing. The knife may have only one position for the blade or may be adjustable allowing multiple positions of the blade from fully retracted to fully extended. The blade generally fits loosely within the slot allowing the blade to bend and break during use.

When the blade becomes worn, dull or breaks the blade may be removed and replaced with a new blade. Some utility knives require the time consuming disassembly of the housing to change the blades wherein a screwdriver is typically employed. Many of the utility knives in the prior art include features for facilitating the changing of the blades without tools. The utility knives of the prior art which include such quick blade change features are not robust enough for use in the device disclosed in a wheeled slitting tool which frequently results in the failure of the locking tabs.

Accordingly, techniques and apparatus for rigidly positioning a knife blade for use with a wheeled slitting tool are desirable.

### SUMMARY OF THE INVENTION

Embodiments of the present invention generally provide techniques and apparatus for rigidly positioning a knife blade within a housing of a wheeled slitting tool.

One embodiment of the present invention provides an apparatus for at least partially slitting a covering or layered material with a wheeled slitting device having a blade positioning device. The apparatus generally includes a blade positioning device that allows for rigid clamping and positioning of a cutting blade relative to the material and further allows for a quick and tool free replacement of the cutting blade.

Another embodiment of the present invention provides for positive locking of the cutting blade within the blade positioning device wherein the components of the blade positioning device include locking tabs and notches that cooperate with notches in the cutting blade prevent the cutting blade from slipping during use.

Yet another embodiment of the present invention provides a method for at partial slitting a covering or layering material. The method generally includes positioning the cutting blade to a predetermined depth of cut and positioning the wheeled slitting tool on top of the material and urging the wheeled slitting tool in a forward direction to produce a slit in the material.

### BRIEF DESCRIPTION OF THE DRAWINGS

So that the manner in which the above-recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 illustrates a side view of an example wheeled slitting tool including a blade positioning device, in accordance with certain aspects of the present invention;

FIG. 2 illustrates a rear view of an example wheeled slitting tool including a blade positioning device, in accordance with certain aspects of the present invention;

FIG. 3 illustrates a front view of an example wheeled slitting tool including a blade positioning device, in accordance with certain aspects of the present invention; and

FIG. 4 illustrates a pre-assembly plan view of a blade positioning device, in accordance with certain aspects of the present invention.

### DETAILED DESCRIPTION

Embodiments of the present invention provide a wheeled slitting tool including a robust blade positioning device, thereby effectively providing a safe and effective tool for slitting horizontally oriented layered materials.

### An Example Wheeled Slitting Tool

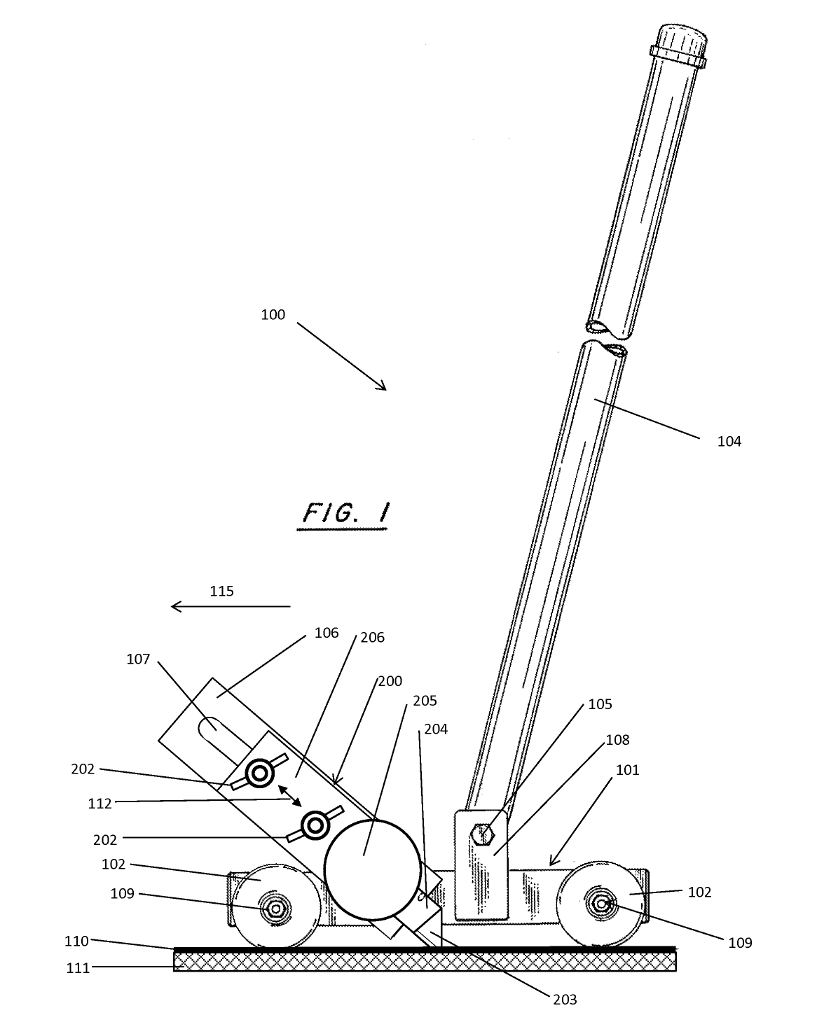

FIGS. 1-3 illustrate an exemplary wheeled slitting tool 100 including blade positioning device 200 in accordance with one embodiment of the present invention. Wheeled slitting tool 100 is further comprised of carriage body 101 having wheels 102 positioned thereon and rotatably fixed to axles 103 and further having handle 104 pivotly attached at bolted joint 105. Blade positioning device 200 is adjustably secured to carriage 101 via rigid mounting plate 106 by bolts 201 and wingnuts 202 within slot 107.

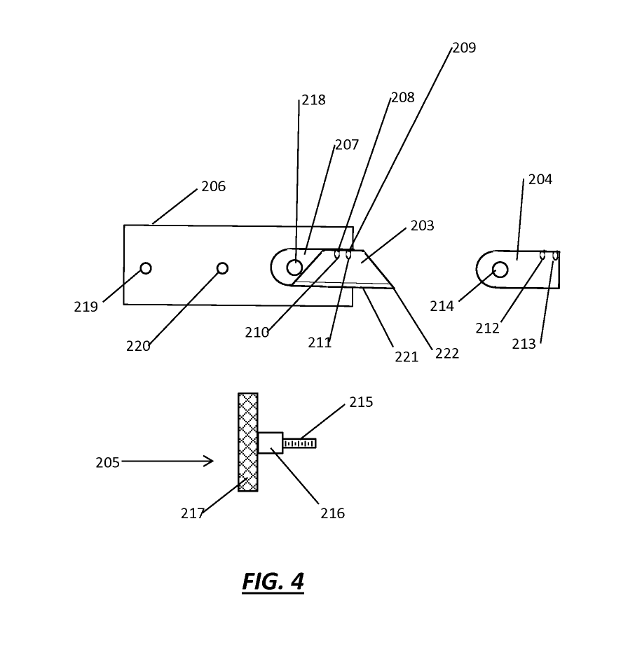

Blade 203 may preferably be any known standard utility knife blade such as Stanley® FatMax® utility blade part number 11-700L. Blade 203 is removably fixed to body 206 of blade positioning device 200 by clamp bar 204 and hand wheel 205 as will be more fully described herein after with reference to FIG. 4. The position of blade 203 is fixed relative to blade positioning device 200 but is linearly adjustable along the adjustment direction 112 with respect to carriage 101 within slot 107. As can be appreciated, the linear adjustment along adjustment direction 107 allows the user to set the depth of the cut.

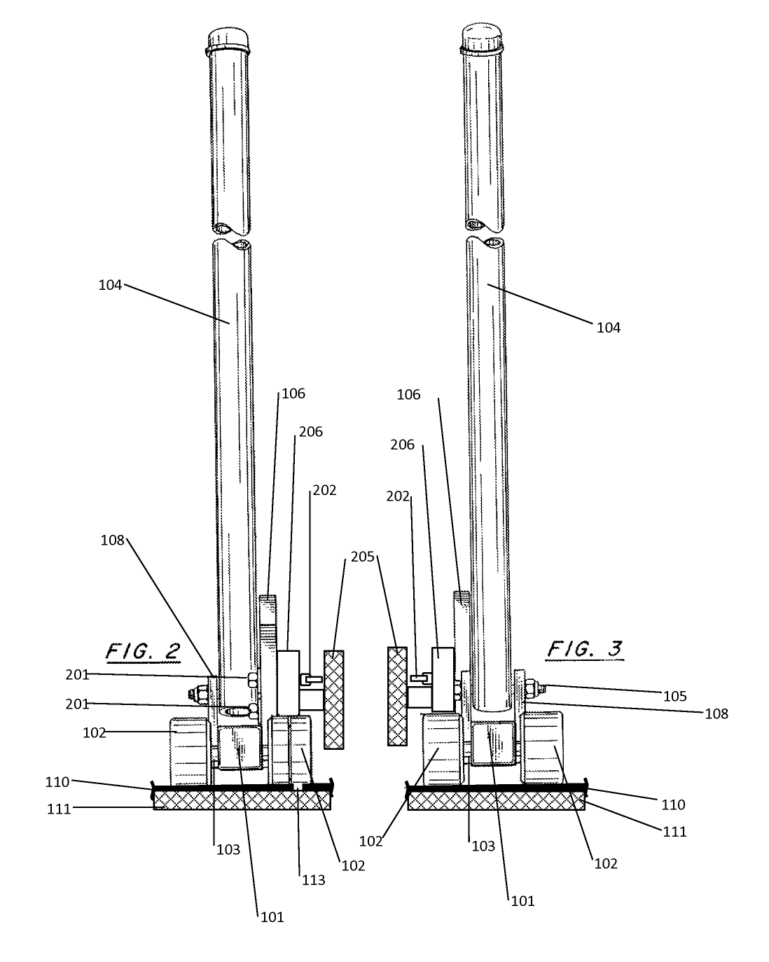

The exemplary wheeled slitting tool 100 may advantageously be used to slit a variety of layered materials 110. Layered material 110 may be any known material applied in a horizontal manner and capable of being at least partially penetrated by a known utility knife as described herein above. Layered material 110 may or may not be adhered to a sub layer 111. An example of a layer material 110 may be a membrane roofing material known in the industry such as TPO or PVC with a sub layer comprised of an insulating board. Other examples of layer material 110 include carpeting, vinyl flooring, plastic sheeting, tarpaulins and the like. The layered material 110 may be partially cut (scored) or cut completely through depending on the thickness and hardness of the layered material 110 and the setting of the blade positioning device 200 along the adjustment direction 112. The position of blade 203 may be adjusted to preserve the integrity of a sub layer 111, as illustrated by cut 113 in FIG. 2, or may be positioned to penetrate the sub layer and multiple layers of material as will be more fully explained herein below. Another advantage of the exemplary embodiment of the wheeled slitting tool 100 is that it can be used to penetrate and slit large contiguous sheets of layered material 110 without the need to provide an access hole in the sheet of layered material.

Carriage 101 may be comprised of steel tubing and joint plates 108 and mounting plate 106 may also be comprised of a suitable steel and may be fixed to carriage 101 in any known manner, such as by welding. Axles 103 may be comprised of a threaded steel rod positioned in wholes (not shown) within carriage 101. Wheels 102 may be comprised of a resilient neoprene material and rotatably fixed to axles 103 by nuts 109.

As illustrated in FIG. 4, the components comprising blade positioning device 200 are shown separately with blade 203 positioned within slot 207 in body 206. Body 206 is adjustably positioned onto mounting plate 106 by passing bolts 201 through slot 107 in the mounting plate, through holes 219, 220 and fixing wingnuts 202 on the bolts. Body 206 is preferably comprised of a steel material and slot 207 may be machined into body 206 by any known method. Slot 207 includes locking tabs 208 and 209 that engage notches 210 and 211 in blade 203 thereby fixing the position of blade 203 relative to body 206. Clamping bar 204 is preferably comprised of a steel material is sized to fit within slot 206 and further includes notches 212 and 213 and a through hole 214. Handwheel 205 is also preferably comprised of a steel material and includes a threaded portion 215, a shoulder 216 and outer surface 217. Outer surface 217 may be knurled to allow for better grip by the user to tighten the assembly as will be more fully explained hereinafter.

The exemplary embodiment of blade positioning device 200 shown in FIG. 4 is assembled by placing blade 203 within slot 207 and engaging notches 208 and 209 with locking tabs 210 and 211 as shown. Clamp bar 204 is then positioned over blade 203 within slot 207 with notches 212 ad 213 engaging locking tabs 208 and 209. Threaded portion 215 of handwheel 205 is inserted into through-hole 217 of clamp bar 204 and threadably engaged within the screw threads of hole 218 within slot 207 of body 206. Blade 203 is then releasably clamped within blade positioning device 200 by urging shoulder 216 against clamp bar 204 by the user hand tightening handwheel 205 within threaded hole 218. The blade positioning device may also include a washer (not shown) between the shoulder 216 and the clamping bar 204. The outer diameter of surface 217 is selected to provide for a tool-less assembly/disassembly by a user while allowing for a high mount of clamping force to be produced through the hand tightening by the user. Unlike the prior art knife housing, with the exception of cutting edge 221 and point end 222 the blade 203 is fully supported within the blade positioning device. The combination of the materials of the body 206, clamping bar 204 and handwheel 205 and the clamping force of shoulder 216 against the clamping bar provides for an extremely rigid support of blade 203.

In practice, when the blade 203 becomes worn, dull or breaks the blade may be removed and replaced quickly with a new blade without the need for tools by the user. The blade replacement procedure begins by first loosening handwheel 205 and unscrewing it a sufficient amount to release both the notches 212, 213 in clamping bar 204 and notches 210, 211 in blade 203 from their engagement with locking tabs 208, 209. Blade 203 can then be removed from slot 107 and discarded. A new blade 203 is then inserted into slot 207 with the notches 210, 211 engaged with locking tabs 208, 209 and clamping bar is similarly positioned within slot 207 with notches 212, 213 engaging locking tabs 208, 209. The user then tightens handwheel 205 providing sufficient hand torque to rigidly clamp blade 203 within assembly 200. The user may then resume use of wheeled slitting tool 100 as described more fully immediately herein below.

### An Example Use of a Wheeled Slitting Tool

The exemplary embodiment will now be described with reference to FIGS. 1-4 as it applies to the slitting and removal of a particular example of a membrane roofing system typical in large commercial style roofs. One such style membrane roof is comprised of single-ply fleece backed thermoplastic polyolefin (TPO) membrane illustrated as layer 110 and further comprised of large sheets of TPO material in 45-60 mil thicknesses and heat weldable along an edge seam to maintain waterproof integrity. The membrane 110 is typically applied on top of a mechanically fastened layer of insulation illustrated as layer 111 and may be self-adhered to the insulation or adhered with a separate layer of glue (not shown). Such membrane roofing systems are well known in the art and available from a variety of manufacturers. The TPO membrane material 110 has a finite life and needs to be removed and replaced periodically to prevent a breach of the roofing system by water from rain or snow. In accordance with the exemplary embodiment of wheeled slitting tool 100 described herein above a user will apply the wheeled slitting tool removed the membrane material 110. The user first installs a blade 203 in the manner described herein before with reference to FIG. 4. The user then determines the thickness of the membrane 110 and adjusts the depth of the cut 113 by loosening wingnuts 202 and sliding blade positioning device 200 along adjustment direction 112 from a retracted position (not shown) to a predetermined depth corresponding to the desired depth of cut in layer 110. The desired position may be set to merely score the material with point 222 of the cutting blade 203 or if a deeper cut is desired it may be positioned along adjustment direction 112 such that cutting edge 221 is employed to slit the covering material 110 and even sub layer 111. Once the desired position has been set, the user tightens wingnuts 202 to fix the blade positioning device 200 relative to the carriage 101. The user then grasps handle 104, places the wheels 102 of wheeled slitting device on the surface of the membrane layer 110, and applies sufficient downward force on handle 104 to permit blade 203 to at least partially penetrate the membrane 110. The user forces the wheeled slitting tool 100 along the slitting direction 115 while walking and pushing the tool. The slitting process is repeated to provide discrete pieces of membrane 110 that may be manageably rolled up and removed from the roof (not shown). If, in the process of slitting membrane 110, the blade 203 becomes worn, dull or breaks, the blade may be removed and replaced quickly with a new blade by the user by employing the replacement procedure described herein above.

While the foregoing is directed to embodiments and uses of the present invention, other and further embodiments of the invention may be devised without departing from the basic scope thereof, and the scope thereof is determined by the claims that follow.

1. An apparatus for at least partially slitting a material comprising:
a carriage body having a plurality of wheels rotatably mounted thereon, a handle bracket, and a mounting plate rigidly positioned on one side of the body, the mounting plate including at least one slotted hole positioned therein;
a handle pivotably mounted to the handle bracket; and
a blade positioning device adjustably attached to the slotted hole of the mounting plate, the blade positioning device comprising:
a body having a slot positioned at an end;
a clamping bar removably positioned in the slot;
a cutting blade removably positioned within the slot between the body and the clamping bar;
a handwheel assembly having a fastening portion on one end and a handwheel on an opposite end, wherein the fastening portion is engaged within the body and positioned to removably clamp the cutting blade between the body and the clamping bar in a tightened position.

2. The apparatus of claim 1 wherein the blade positioning device further comprises at least one locking tab disposed within the slot and at least one notch disposed within the cutting blade wherein the locking tab engages the at least on notch to prevent linear motion of the cutting blade relative to the blade positioning device.

3. The apparatus of claim 2 wherein the at least one notch disposed within the clamping bar wherein the locking tab engages the at least on notch.

4. The apparatus of claim 1 wherein the handwheel assembly further comprises a shoulder portion between the handwheel end and the fastening end that engages the clamping bar in the tightened position.

5. The apparatus of claim 1 wherein the blade positioning device is adjustable between a retracted position and an extended position wherein the extended position is related to a predetermined depth of cut.

6. An apparatus for at least partially slitting a material comprising:
a carriage body having four wheels rotatably mounted thereon and defining a plane, a handle bracket, and a mounting plate rigidly positioned on one side of the body, the mounting plate including at least one slotted hole positioned therein;
a handle pivotably mounted to the handle bracket; and
a blade positioning device adjustably attached to the slotted hole of the mounting plate, the blade positioning device comprising:
a body having a slot positioned at an end and a pair of locking tabs disposed within the slot;
a clamping bar removably positioned in the slot and having a pair of notches engaged with the pair of locking tabs;
a cutting blade removably positioned within the slot between the body and the clamping bar, the clamping bar including a pair of notches engaged with the pair of locking tabs;
a handwheel assembly having a threaded portion on one end and a handwheel on an opposite end and a shoulder positioned therebetween, wherein the threaded portion is threadably engaged within the body and positioned to removably clamp the cutting blade between the body and the clamping bar engaging the shoulder against the clamping bar in a tightened position.

7. The apparatus of claim 7 wherein the material is positioned in a horizontal orientation, the blade positioning device is adjusted to a predetermined depth of cut, the wheels are positioned on a top side of the material and the blade penetrates the material to the predetermined depth of cut.

8. The apparatus of claim 7 wherein the material is a roofing membrane material.

9. A method of at least partially slitting a material comprising:
providing a wheeled slitting apparatus including an adjustable blade positioning device wherein the blade positioning device includes a cutting blade positioned between a body and a clamping bar removably clamped by a handwheel assembly;
adjusting the cutting blade position to a predetermined cutting depth;
positioning the wheeled slitting apparatus on a top surface of the material; and
penetrating the material with the blade to the predetermined cutting depth.

10. The method of claim 9 further comprising urging the wheeled slitting apparatus in a forward direction and making a longitudinal slit in the material.
